(19) United States
(12) Patent Application Publication
(10) Pub. No.: US 2020/0033298 A1
(43) Pub. Date: Jan. 30, 2020

(54) METHODS, SYSTEMS, AND COMPUTER READABLE MEDIA FOR TRANSLATING SAMPLE PLATE OVER FIXED ULTRASOUND TRANSDUCER

(71) Applicant: The University of North Carolina at Chapel Hill, Chapel Hill, NC (US)

(72) Inventors: Paul Alexander Dayton, Carboro, NC (US); Samantha Gail Pattenden, Mebane, NC (US); Marjan Mehrab Mohseni, Chapel Hill, NC (US); Sandeep Kasoji, Durham, NC (US); Kazuya James Tsunuta, Chapel Hill, NC (US); Eric Nathan Marlkey, Chapel Hill, NC (US)

(21) Appl. No.: 16/521,183

(22) Filed: Jul. 24, 2019

Related U.S. Application Data
(60) Provisional application No. 62/702,694, filed on Jul. 24, 2018.

(51) Int. Cl. G01N 29/27

(52) U.S. Cl. CPC G01N 29/27

(57) ABSTRACT

A system for translating a sample plate over a fixed ultrasound transducer includes a sample plate holder holding a sample plate containing samples to be sonicated. A first actuator translates the sample plate linearly across a non-uniform ultrasound energy field output from a fixed ultrasound transducer.

### PRIORITY CLAIM

This application claims the benefit of U.S. Provisional Patent Application Serial No. 62/702,694, filed Jul. 24, 2018, the disclosure of which is incorporated herein by reference in its entirety.

### GOVERNMENT INTEREST

This invention was made with government support under Grant No. CA206939-01 A1 awarded by the National Institutes of Health. The government has certain rights in the invention.

### TECHNICAL FIELD

The subject matter described herein relates to sonicating ultrasound samples where the samples reside in a sample plate. More particularly, the subject matter described herein relates to methods, systems, and computer readable media for translating a sample plate over a fixed ultrasound transducer.

### BACKGROUND

In sonicating biological, chemical, or industrial samples, it is desirable to achieve uniformity or near uniformity in application of ultrasound energy to the samples to achieve consistent results. Ultrasound transducers used to sonicate samples typically include a circular horn that generates the ultrasound energy field. One method for achieving uniformity or near uniformity in sample sonication is to arrange the samples in a circular pattern consistent with the shape of the ultrasound horn and rotate the circular arrangement of samples within the ultrasound energy field. However, arranging samples in a circular pattern may be inconvenient because most sample plates, such as 96 or 384 well microtiter plates are rectangular. Sonicating samples in a rectangular sample plate using a circular ultrasound horn may lead to uneven and inconsistent sonication of samples.

Accordingly, there exists a need for methods, systems, and computer readable media for translating a sample plate over a fixed ultrasound transducer.

### SUMMARY

A system for translating a sample plate through an ultrasound energy field produced by a fixed ultrasound transducer includes a sample plate holder holding a sample plate containing samples to be sonicated. A first actuator translates the sample plate linearly across a non-uniform ultrasound energy field output from a fixed ultrasound transducer.

A method for sonicating samples in a sample plate includes placing samples in wells of a multi-well sample plate. The method includes placing the sample plate in a sample plate holder. The method further includes activating an ultrasound transducer, which produces a non-uniform ultrasound energy field. The method further includes, while activating the ultrasound transducer, activating a first actuator to translate the sample plate linearly across the non-uniform ultrasound energy field.

The subject matter described herein may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings of which:

FIG. 1A is a perspective view of a system for translating a sample plate over a fixed ultrasound transducer;

FIG. 1B is a perspective view of an alternate implementation of a system for translating a sample plate over a fixed ultrasound transducer.

FIG. 2 is a top view of an ultrasound energy field produced by a circular ultrasound transducer horn and a footprint of a sample plate superimposed on the ultrasound energy field;

FIG. 3A illustrates linear movement of a sample plate across a non-uniform ultrasound energy field;

FIG. 3B illustrates linear movement of a sample plate across a non-uniform ultrasound energy field in a direction orthogonal to the direction in FIG. 3A;

FIG. 3C illustrates linear translation of a sample plate across a non-uniform ultrasound energy field in the direction opposite the direction illustrated in FIG. 3A;

FIG. 3D illustrates linear translation of a sample plate across a non-uniform ultrasound energy field in a direction opposite the direction illustrated in FIG. 3B; and

FIG. 4 is a flow chart illustrating an exemplary process for sonicating a sample in a non-uniform ultrasound energy field.

### DETAILED DESCRIPTION

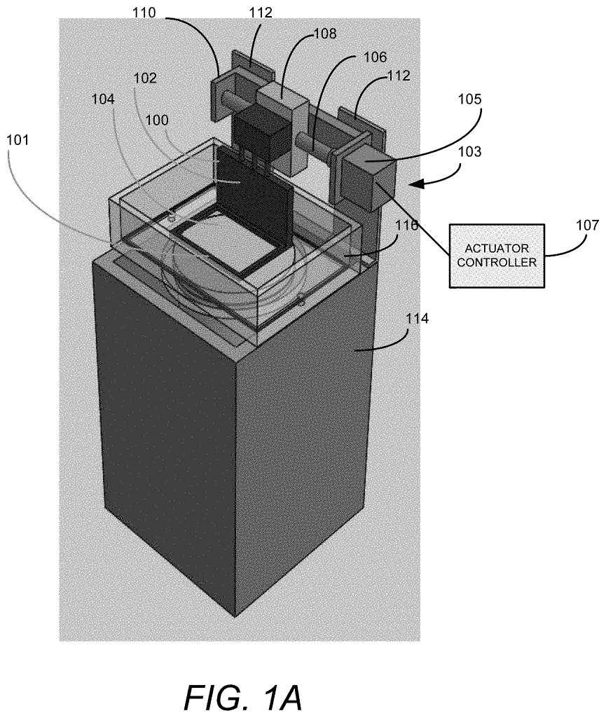

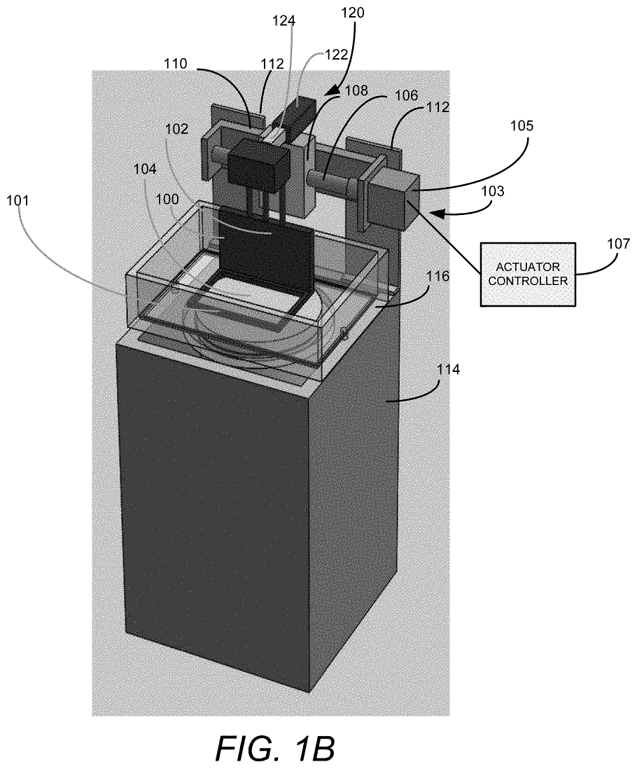

FIG. 1A is a perspective view of a system for translating a sample plate across a non-uniform ultrasound energy field. In FIG. 1, the system includes a sample plate holder 100, which in the illustrated example is designed to hold a 96 well rectangular microtiter plate. The subject matter described herein can be used to hold any shape of sample plate, including, but not limited to a 384 well plate. Sample plate holder 100 includes a plate receiving portion 101 forming a rectangular aperture for receiving a microtiter-plate. Sample plate holder 100 further includes an actuator connection portion 102 for connecting sample plate holder 100 to an actuator. Actuator connection portion 102 is connected to plate receiving portion 101 at an orthogonal angle. In one implementation, plate receiving portion 101 or the entire sample plate holder 100 may be removably coupled to the remainder of the system illustrated in FIG. 1A and available in different sizes to match difference sizes of sample plates.

The system further includes an actuator 103 for translating sample plate holder 100 across an ultrasound energy field produced by an ultrasound transducer horn 104. In the illustrated example, actuator 103 includes a motor 105 and a sample movement arm 106 to which sample plate holder 100 is coupled. Sample movement arm 106 is also coupled to the shaft of motor 105. A movable mounting block 108 is rigidly connected to sample plate holder 100 and movably connected to sample movement arm 106 such that movement of the shaft of motor 105 causes movement of sample movement arm 106, which causes linear movement of sample plate holder 100.

In one example, sample movement arm 106 comprises a lead screw, which includes a spiral gear formed on its outer circumference that meshes with a corresponding spiral gear located on the inner surface of a cylindrical aperture in movable mounting block 108 though which the lead screw extends. When an actuator controller 107 supplies a control signal to actuator 103, the shaft of motor 105 rotates to cause the lead screw to rotate, which causes movable mounting block 108 to move or translate linearly along the axis of the lead screw and across the non-uniform ultrasound energy field output from ultrasound transducer horn 104.

A support member 110 holds sample movement arm 106 and stepper motor 105 in place above ultrasound transducer horn 104. A pair of mounting brackets 112 connect support member 110 to a sound proof enclosure 114. Sound proof enclosure 114 encloses an ultrasound transducer that produces the ultrasound energy output by ultrasound transducer horn 104.

Fluid container 116 encloses sample plate holder 100 from beneath and on all lateral sides. In operation, fluid container 116 is typically filled (partially) with a liquid, such as water, to increase conduction of ultrasound energy during sonication. Fluid container 116 is mounted on top of sound proof enclosure 114 and includes an aperture though which ultrasound transducer horn 104 extends. A seal, such as an o ring, provides a liquid proof seal between the aperture in fluid container 116 and ultrasound transducer horn 104. In one example, fluid container 116 may be made of an optically translucent material, such as an acrylic material.

During sonication, the sample plate may be maintained in a fluid solution within fluid container 116. More particularly, the sample plate may be positioned so that the bottom of the plate resides in the fluid solution. Transducer horn 104 may also be located in the fluid solution such that a portion of transducer horn 104 extends into fluid container 116 through the aperture and is covered by the fluid solution. The fluid solution may be maintained at a temperature between any of the following ranges: (−10 and 0) (0 and +10) (0 and +20) degrees C. to preserve the integrity of the sample during exposure to ultrasound energy.

In FIG. 1A, the system is capable of moving sample plate holder 100 in one dimension. In an alternate implementation, the system may be capable of moving sample plate holder 100 in two dimensions. FIG. 1B illustrates such an implementation. In FIG. 1B, the correspondingly numbered elements are the same as those illustrated in FIG. 1A. Hence, a description thereof will not be repeated. In addition to the components illustrated in FIG. 1A, the system illustrated in FIG. 1B includes a second actuator 120 for moving sample plate holder 100 linearly in a direction orthogonal to the direction of movement produced by actuator 103. Second actuator 120 may include a drive motor 122 fixedly attached to movable mounting block 108. A telescoping arm 124 extends outward from a housing of drive motor 122 and is connected to sample plate holder 100. When drive motor 122 is activated by actuator controller 107, telescoping arm 124 telescopes outward from or retracts into the housing enclosing drive motor 122 in accordance with a desired direction of movement of sample plate holder 100.

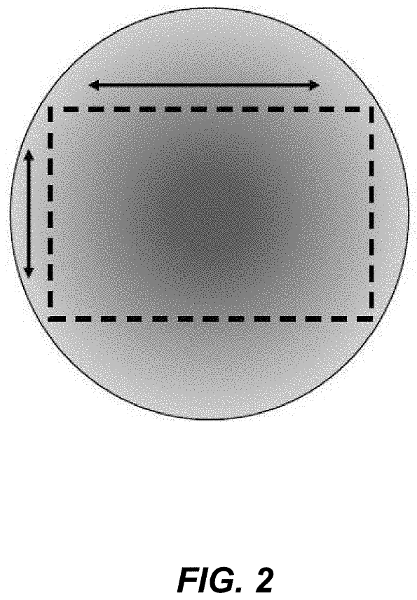

FIG. 2 is a diagram illustrating an ultrasound energy field and movement of a sample plate within the ultrasound energy field. In FIG. 2, the shading represents the uneven acoustic field due to the circular aperture of the ultrasonic horn. The dotted line in FIG. 2 represents the footprint of a rectangular sample plate. Due to the incongruity between the rectangular profile of the sample plate and the circular profile of the ultrasound transducer horn, samples located near the edges of the sample plate are exposed to a lower amount of ultrasound energy than samples near the center of the sample plate. Linear translation of the sample plate in one or two dimensions will ensure a more even exposure of the samples to ultrasound energy.

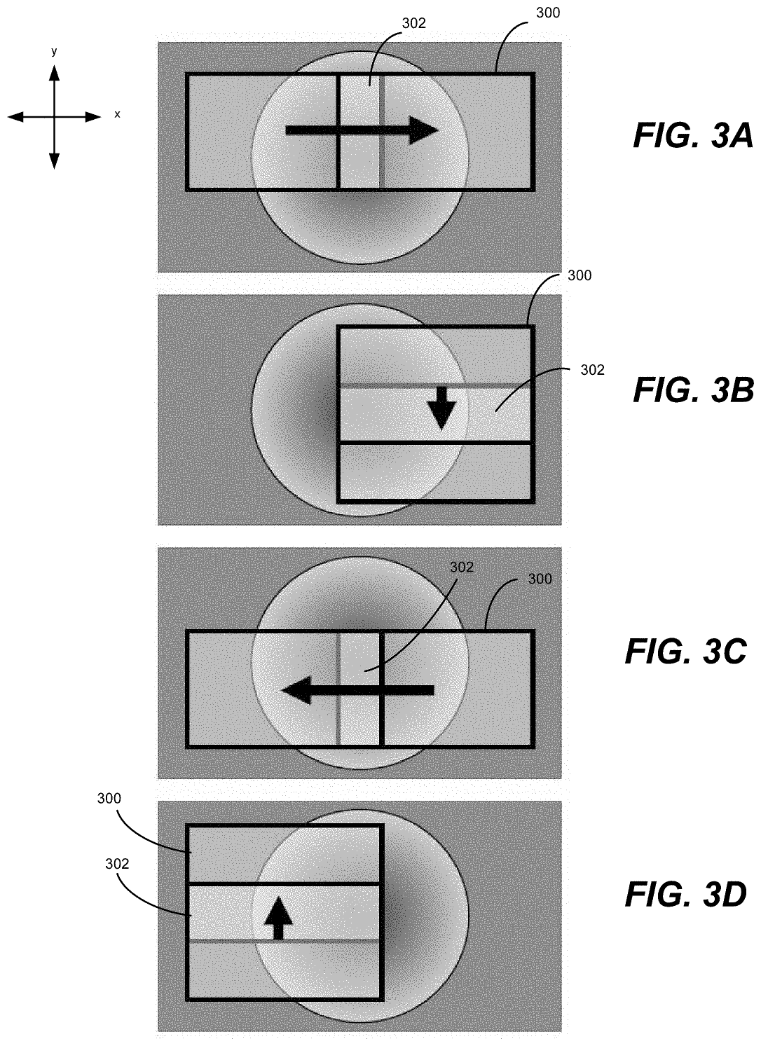

FIGS. 3A-3D illustrate linear translation of the sample plate across a non-uniform ultrasound energy field. In FIGS. 3A-3D, rectangles 300 represent the path traveled by a sample plate 302 in a given direction. The coordinate axis on the left-hand side of FIG. 3A is used as a frame of reference for the direction of travel of the sample plate. Using this coordinate system as a reference, FIG. 3A illustrates the path traveled by the sample plate in the positive x direction. FIG. 3B illustrates the path traveled by the sample plate in the negative y direction. FIG. 3C illustrates the path traveled by the sample plate in the negative x direction. FIG. 3D illustrates the path traveled by the sample plate in the positive y direction.

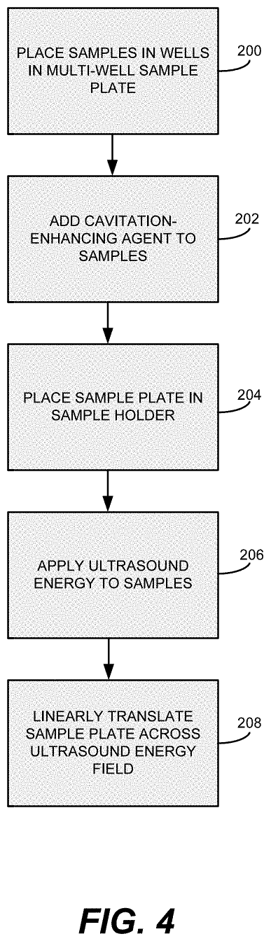

FIG. 4 is a flow chart illustrating the exemplary process for sonicating a sample in a non-uniform ultrasound energy field. Referring to FIG. 4, step 200, ultrasound samples to be sonicated are placed in wells in a multi-well sample plate. For example, biological samples, chemical samples, industrial samples, etc. may be placed in wells of a microtiter plate, such as a 96 well microtiter plate.

In step 202, an ultrasound a cavitation-enhancing agent may be added to the samples. In one example, lipid-encapsulated nanodroplets may be added to the samples in the sample plates to enhance transfer of ultrasound energy to the samples. The lipid-encapsulated nanodroplets may be any of those described in U.S. Pat. No. 9,427,410, the disclosure of which is incorporated herein by reference in its entirety. It should be noted that the nanodroplets may be added to the wells in the sample plate before, after, or simultaneously with the samples.

In step 204, the sample plate is placed within a linearly translatable sample plate holder. For example, the sample plate may be placed in sample plate holder 100 illustrated in FIGS. 1A and 1B. It should also be noted that the samples and the cavitation-enhancing agent can be placed in the wells of the sample plate after the sample plate is placed in sample plate holder 100.

In step 206, ultrasound energy is applied to the samples by activating an ultrasound transducer located proximately to the sample plate. In the examples illustrated in FIGS. 1A and 1B, the ultrasound transducer is located within sound proof enclosure 114. Ultrasound energy is output through ultrasound transducer horn 104 and conducted to the sample plate through a liquid present in fluid container 116.

In step 208, the sample plate is linearly translated across the ultrasound energy field. For example, actuators 103 and 120 may each be controlled to move sample plate holder linearly across the ultrasound energy field output through horn 104. Motion may be effected in one or two dimensions, as illustrated in FIGS. 3A-3D. It should be noted that steps 206 and 208 can be synchronized such that the application of the ultrasound energy to the samples and the translation of the samples across the ultrasound energy field occur simultaneously.

It should also be noted that all of the steps illustrated in FIG. 4 can be automated. The placement of the samples in the sample plate and the addition of the ultrasound contrast agent to the samples can be performed by a robotic arm of the type used for high throughput screening of biological samples. Such a robotic arm includes sample dispensers located on an end of the arm and suitable for injecting or otherwise placing samples in wells of a multi-well plate. The placement of the sample plate in the sample plate holder can also be performed automatically by a robotic arm or manually by a user. In the fully automated cases, all of the steps illustrated in FIG. 4 may be controlled by computer-executable instructions embodied in a non-transitory computer readable medium that controls the various robots and actuators.

In the examples illustrated in FIGS. 1A and 1B, actuator 103 comprises a stepper motor and a lead screw, and actuator 120 comprises a motor and a telescoping arm. However, the subject matter described herein is not limited to these types of actuators. Any actuator or combination of actuators capable of linearly translating a sample plate through an ultrasound energy field are intended to be within the scope of the subject matter described herein. In an alternate implementation, a rotary to linear motion actuator, such as a rotary engine coupled to a piston could be used as either or both of actuators 103 and 120. In addition, the subject matter described herein is not limited to using a stepper motor to drive motion of the sample plate holder. In alternate implementation, an AC motor, a piezoelectric motor, or other type of motor can be used without departing form the scope of the subject matter described herein.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A system for translating a sample plate over a fixed ultrasound transducer, the system comprising:
a sample plate holder holding a sample plate containing samples to be sonicated; and
a first actuator for translating the sample plate linearly across a non-uniform ultrasound energy field output from a fixed ultrasound transducer.

2. The system of claim 1 wherein the sample plate holder is designed to hold a rectangular microtiter plate.

3. The system of claim 2 wherein the sample plate holder is designed to hold a 96 or 384 well microtiter plate.

4. The system of claim 1 wherein the first actuator comprises:
a motor;
a sample movement arm coupled to the motor; and
a movable mounting block fixedly connected to the sample plate holder and movable connected to the sample movement arm, wherein rotation of a shaft of the motor causes movement of the sample movement arm and the movable mounting block across the sample movement arm to move the sample plate holder linearly across the non-uniform ultrasound energy field output from the ultrasound transducer.

5. The system of claim 4 wherein the sample movement arm comprises a lead screw and rotation of the lead screw effects movement of the movable mounting block.

6. The system of claim 1 wherein the first actuator is configured to move the sample plate holder in one dimension.

7. The system of claim 1 comprising a second actuator coupled to the sample plate holder for moving the sample plate holder linearly in a direction orthogonal to a direction of movement of the sample plate holder produced by the first actuator.

8. The system of claim 7 wherein the second actuator comprises:
a motor having a housing; and
a telescoping arm extending from the housing and coupled to the sample plate holder, wherein activation of the motor causes the telescoping arm to telescope from and retract into the housing and effect linear movement of the sample plate holder in the direction orthogonal to the direction of movement produced by the first actuator.

9. The system of claim 1 comprising a fluid container for holding a fluid for coupling the sample plate to the ultrasound transducer.

10. A method for sonicating samples in a sample plate, the method comprising:
placing samples in wells of a multi-well sample plate;
placing the sample plate in a sample plate holder; and
activating an ultrasound transducer, which produces a non-uniform ultrasound energy field; and
while activating the ultrasound transducer, activating a first actuator to translate the sample plate linearly across the non-uniform ultrasound energy field.

11. The method of claim 10 wherein the sample plate holder is designed to hold a rectangular microtiter plate.

12. The method of claim 11 wherein the sample plate holder is designed to hold a 96 or 384 well microtiter plate.

13. The method of claim 10 wherein the first actuator comprises:
a motor;
a sample movement arm coupled to the motor; and
a movable mounting block fixedly connected to the sample plate holder and movable connected to the sample movement arm, wherein rotation of a shaft of the motor causes movement of the sample movement arm and the movable mounting block across the sample movement arm to move the sample plate holder linearly across the non-uniform ultrasound energy field output from the ultrasound transducer.

14. The method of claim 13 wherein the sample movement arm comprises a lead screw and rotation of the lead screw effects movement of the movable mounting block.

15. The method of claim 10 wherein the first actuator is configured to move the sample plate holder in one dimension.

16. The method of claim 10 comprising activating a second actuator coupled to the sample plate holder for moving the sample plate holder linearly in a direction orthogonal to a direction of movement of the sample plate holder produced by the first actuator.

17. The method of claim 16 wherein the second actuator comprises:
a motor having a housing; and
a telescoping arm extending from the housing and coupled to the sample plate holder, wherein activation of the motor causes the telescoping arm to telescope from and retract into the housing and effect linear movement of the sample plate holder in the direction orthogonal to the direction of movement produced by the first actuator.

18. The method of claim 10 comprising, prior to translating the sample plate linearly across the non-uniform ultrasound energy field, adding a cavitation-enhancing agent to the samples.

19. The method of claim 18 wherein the cavitation-enhancing agent includes lipid-encapsulated nanodroplets.

20. The method of claim 10 comprising providing a fluid container for holding a fluid for coupling the sample plate to the ultrasound transducer.

21. A non-transitory computer-readable medium having stored thereon executable instructions that when executed by a processor of a computer control the computer to perform steps comprising:
placing samples in wells of a multi-well sample plate;
placing the sample plate in a sample plate holder;
activating an ultrasound transducer, which produces a non-uniform ultrasound energy field; and
while activating the ultrasound transducer, activating a first actuator to translate the sample plate linearly across the non-uniform ultrasound energy field.
